(19) United States
(12) Patent Application Publication
(10) Pub. No.: US 2020/0293954 A1
(43) Pub. Date: Sep. 17, 2020

(54) Device, Method, and Program for Depositing Baggage at Store

(71) Applicant: ECBO, Inc., Shibuya-ku (JP)

(72) Inventor: Weihang YE, Shibuya-ku (JP)

(21) Appl. No.: 16/476,771

(22) PCT Filed: Jan. 9, 2018
(86) PCT No.: PCT/JP2018/000225

§ 371 Date: Sep. 23, 2019

(30) Foreign Application Priority Data
Jan. 9, 2017 (JP) 2017-001521

(51) Int. Cl. G06Q 10/02; G06Q 50/14

(52) U.S. Cl. CPC G06Q 10/02; G06Q 50/14

(57) ABSTRACT

A method using a shop device for keeping one or more pieces of baggage of a user at a shop, comprising steps of: displaying reservation contents of the user to a display of the shop device, photographing the one or more pieces of baggage of the user included in the reservation contents, and sending a photograph of each of the one or more pieces of baggage or a photograph corresponding thereto.

### TECHNICAL FIELD

The present invention relates to a device, method and program for keeping a luggage at a shop.

### BACKGROUND ART

In recent years, foreign tourists are rapidly increasing in Japan, and it is common to see tourists carrying baggage while moving between the destinations or before and after entering and leaving the country. In addition, when an event such as a live concert is held, it is often the case that people with suitcases are seen around the venue.

Currently, coin lockers are mainly used as means for temporarily keeping luggage such as suitcases.

### SUMMARY OF INVENTION

### Technical Problem

However, there are not a few problems with coin lockers. First, for example, at Shibuya Station, it is not clear where coin lockers are except for those who are using Shibuya Station on daily basis. Next, even if you find a coin locker, it is not uncommon that it is occupied. This is because there are only 1000 to 2000 coin lockers in Shibuya. Furthermore, when coin lockers of the size where a large suitcase can be stored are considered, they are limited to a few percentages of the whole, and the situation that a suitcase cannot be stored even if a coin locker is found has arisen. This situation is expected to become more serious due to the increasing number of foreigners visiting Japan in the future. In other words, there is a need to improve the mechanism for temporarily keeping baggage.

The present invention has been made in view of such a problem, and the objective thereof is to, in a device, method and program for keeping a baggage, reduce a burden on a user who deposits a baggage.

### Solution to Problem

In order to achieve such an objective, the first aspect of the present invention is a method using a shop device for keeping one or more pieces of baggage of a user at a shop, comprising steps of: displaying reservation contents of the user to a display of the shop device, photographing the one or more pieces of baggage of the user in line with the reservation contents, and sending a photograph of each of the one or more pieces of baggage or a photograph corresponding thereto.

Further, the second aspect of the present invention according to the first aspect is characterized in that the shop device is a portable terminal.

Further, the third aspect of the present invention according to the first or second aspect is characterized in that the one or more pieces of baggage is hand baggage.

Furthermore, the fourth aspect of the present invention according to the first or second aspect is characterized in that the one or more pieces of baggage include pieces of baggage respectively pertaining to different size categories.

Further, the fifth aspect of the present invention according to any of the first to fourth aspects is characterized in that the reservation contents include a face photo or a profile photo of the user.

Further, the sixth aspect of the present invention according to any one of the first to fifth aspects is characterized in that the photograph of each of the one or more pieces of baggage or the photograph corresponding thereto can be displayed on the shop device.

Further, the seventh aspect of the present invention according to the sixth aspect is characterized in that at least part of the photograph of each of the one or more pieces of baggage or the photograph corresponding thereto is displayed on the shop device together with the face photo or the profile photo of the user.

Further, the eighth aspect of the present invention according to any one of the first to seventh aspects is characterized in that the sending is uploading to a server which can communicate with the shop device.

Further, the ninth aspect of the present invention according to the eighth aspect is characterized in that the photograph of each of the one or more pieces of baggage or the photograph corresponding thereto uploaded to the server is displayed on a user terminal of the user.

Further, the tenth aspect of the present invention according to any one of the first to seventh aspects is characterized in that the sending is sending from the shop device to the user terminal.

Further, the eleventh aspect of the present invention according to any one of the eighth to tenth aspects further comprises a step of determining completion of check-in of the one or more pieces of baggage in response to completion of the sending.

Further, the twelfth aspect of the present invention according to any one of the first to eleventh aspects is characterized in that the photograph of each of the one or more pieces of baggage or the photograph corresponding thereto includes an identification symbol.

Further, the thirteenth aspect of the present invention according to any one of the first to the twelfth aspects is characterized in that whether each piece of baggage can be returned is determined based on a matching result between the photograph of each of the one or more pieces of baggage or the photograph corresponding thereto which the user displayed on a user terminal and a photograph that can be displayed on the shop device.

Further, the fourteenth aspect of the present invention is a program for having a shop device to perform a method for keeping one or more pieces of baggage of a user at a shop, the method comprising steps of: displaying reservation contents of the user to a display of the shop device, photographing the one or more pieces of baggage of the user in line with the reservation contents, and sending a photograph of each of the one or more pieces of baggage or a photograph corresponding thereto.

Further, the fifteenth aspect of the present invention is a shop device for keeping one or more pieces of baggage of a user at a shop, comprising: a display for displaying reservation contents of the user, photographing unit for photographing the one or more pieces of baggage of the user in line with the reservation contents, and communication unit for sending a photograph of each of the one or more pieces of baggage or a photograph corresponding thereto.

A sixteenth aspect of the present invention is a method using a shop device for keeping one or more pieces of baggage of a user at a shop, comprising steps of: causing reservation contents of the user to be displayed on display of the shop device, receiving one or more photographs of the one or more pieces of baggage of the user photographed in line with the reservation contents or one or more photographs corresponding thereto, and sending the received one or more photographs or one or more photographs corresponding thereto to a user terminal of the user.

### Advantageous Effect of Invention

According to one aspect of the present invention, there is provided a device, method and program for keeping baggage, which can reduce the burden on a user who deposits baggage by performing baggage keeping using visual communication via a photograph or an image.

### BRIEF DESCRIPTION OF DRAWINGS

FIG. 1 is a figure showing a display example of shops on a user terminal according to an aspect of the present invention.

FIG. 2 is a figure showing a reservation screen on a user terminal according to an aspect of the present invention.

FIG. 3 is a figure showing a confirmation screen of reservation contents and usage fee on the user terminal according to one aspect of the present invention.

FIG. 4 is a figure showing a check-in screen on a shop terminal according to one aspect of the present invention.

FIG. 5 is a figure showing a system for a baggage keeping platform including a shop device according to an aspect of the present invention.

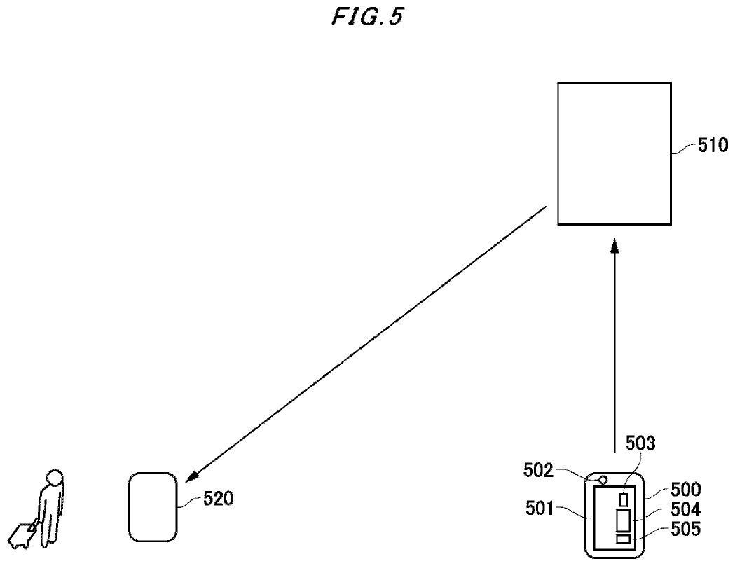

FIG. 6 is a figure showing a photographing screen on a shop terminal according to one aspect of the present invention.

FIG. 7 is a figure showing a UL completion screen on a shop terminal according to one aspect of the present invention.

FIG. 8 is a figure showing a reservation management screen on a shop terminal according to an aspect of the present invention.

FIG. 9 is a flowchart of a shop device from check-in to check-out according to one embodiment of the present invention.

### DESCRIPTION OF EMBODIMENTS

Hereinafter, embodiments of the present invention will be described in detail with reference to the drawings.

### (Outline of Present Invention)

The present invention aims to effectively utilize facilities other than coin lockers because it is not easy to increase the supply amount of coin lockers in a short period of time. As a facility, a focus is put on shops selling goods or providing services and for example places not used temporarily, intermittently, or in the medium to long term, that is, idle spaces are utilized.

First, a shop is registered. In addition to shop name and at least one of the address or the position on a map, part of or all of the followings may be input by the shop registering party as shop registration information: at least one of the total number or the number per size of baggage that can be stored, the date and time when storage is allowed, the nearest station, walking time from the nearest station, telephone number, contact information such as e-mail address, business hours, holidays, Wi-Fi (registered trademark), presence or absence of facilities such as power source, shop URL, shop photos, and remarks such as pet OK etc.

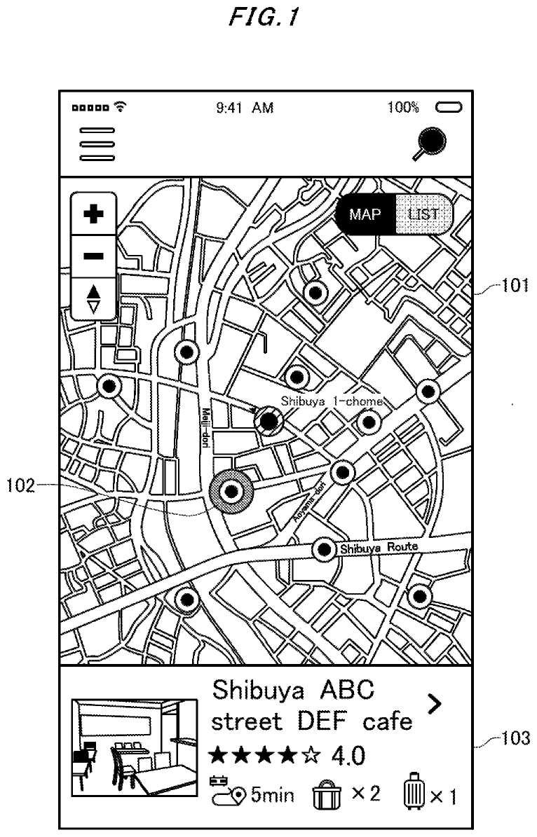

The information about each registered shop can be viewed or searched by a user from a website on a server for providing this baggage keeping platform or from an application for a user installed on a portable terminal such as a smartphone, tablet or the like that can communicate with the server. FIG. 1 shows an example in which the shop position 102 is shown on the map 101 of the application, and the outline of the shop is shown for example in the lower area 103 of the display screen when the user selects it. Alternatively, a list of shops can be displayed.

The user may add some part of the information later, but in advance input part of all of contact information such as telephone number and e-mail address, face photo, payment information such as credit card number, nationality or residence, besides the name or its abbreviation, from the website or app as the user registration information.

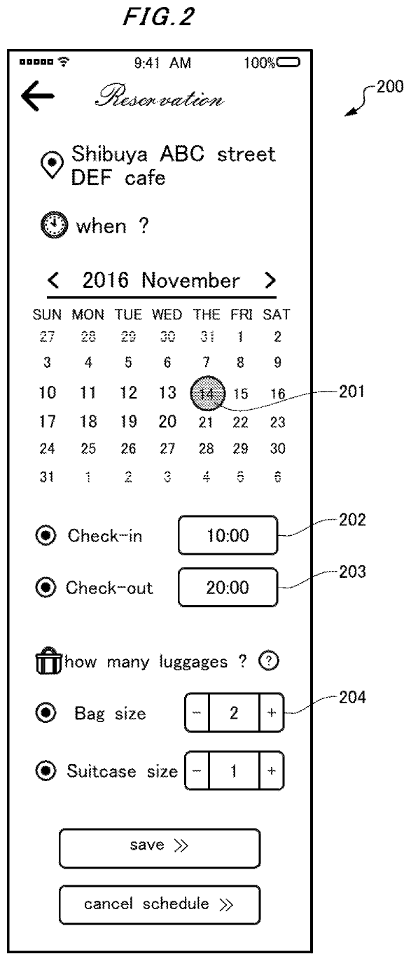

In order to make a reservation, the user selects a shop, confirms the summary or details, and inputs reservation information on when and what to deposit from the website or the application. Logging in to the baggage keeping service can be performed not only before entering the baggage information but also after entering. FIG. 2 shows an example of a reservation screen 200 for entering or selecting the date 201 for depositing baggage, check-in time 202, check-out time 203, and the number 204 of packages per size or size category after selecting a shop in the application. Here, in the present specification, “check in” means that a user performs a procedure for depositing a package, and “check out” means that a user performs a procedure for receiving a package deposited by the user.

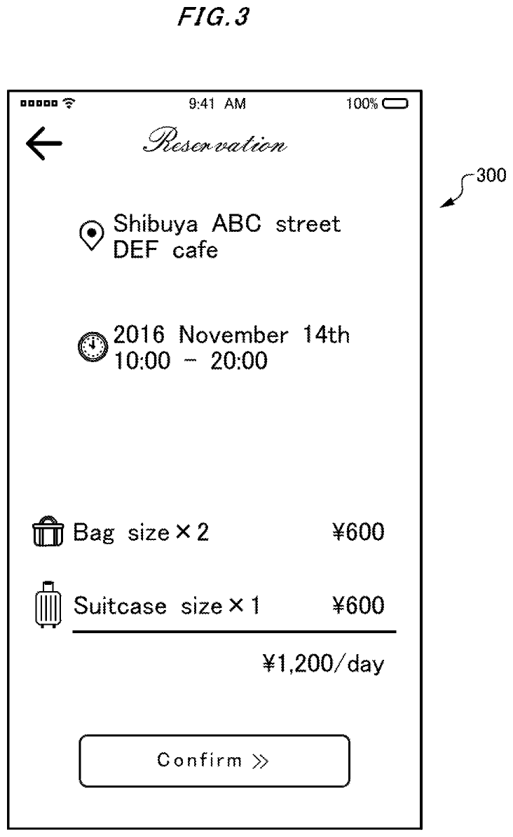

After the reservation information is input or selected, as shown in FIG. 3, the reservation contents and the charge for use are presented to the user on the confirmation screen 300, and when confirmation is done, the reservation is completed.

In the present invention, when the user visits the shop at the reserved date and time, the employee of the shop photographs and saves the luggage of the user using a mobile terminal such as a smartphone or a tablet, and also sends the photo as a certificate of receipt to a mobile terminal used by the user. By doing this, the user does not have to search for a coin locker, but needs only to visit a more easy-to-find shop, and also it is sufficient to hand the baggage to the shop employee. The burden conventionally imposed on the user is greatly reduced.

### (Details of Certificate of Receipt)

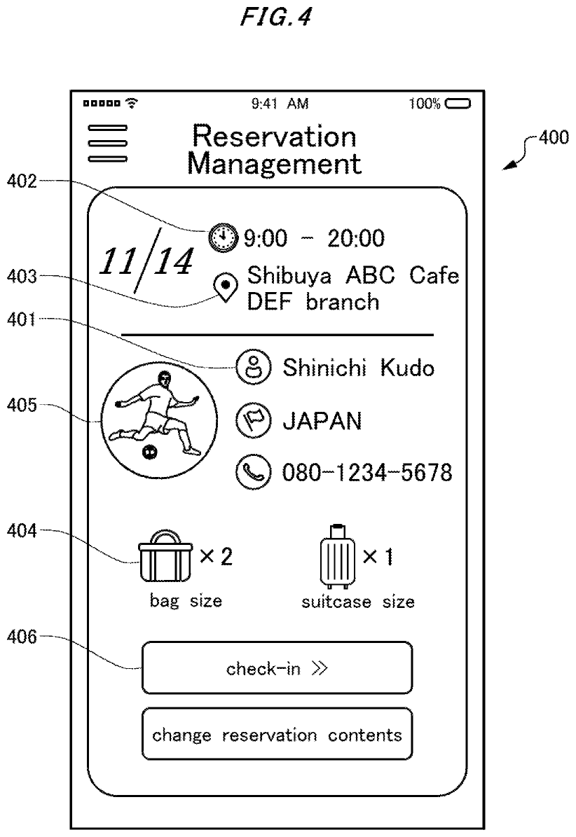

FIG. 4 shows a check-in screen on the shop terminal according to one aspect of the present invention. The shop device 500 used by the shop employee is configured by installing a shop application on a device capable of communicating with the server 510 for providing the package keeping platform. Alternatively, it is configured by receiving the source code for displaying each screen as a web page from the server 510. The shop device 500 is desirably a portable terminal such as a smartphone or a tablet, and in this case, the shop device 500 may be referred to as a shop terminal. When logged a list of reservations can be browsed on the shop device 500, and the check-in screen 400 is displayed by selecting the reservation of a visiting user. The reservation may be searchable in addition to selection from the list.

On the check-in screen 400, reservation contents such as reservation person 401, reservation time 402, shop name 403, number of pieces of baggage 404, face picture or profile picture 405, check-in button 406 and the like are displayed. As long as the reservation can be uniquely identified, shop name 403, number of pieces of baggage 404, profile picture 405, etc. are not necessarily displayed on this screen.

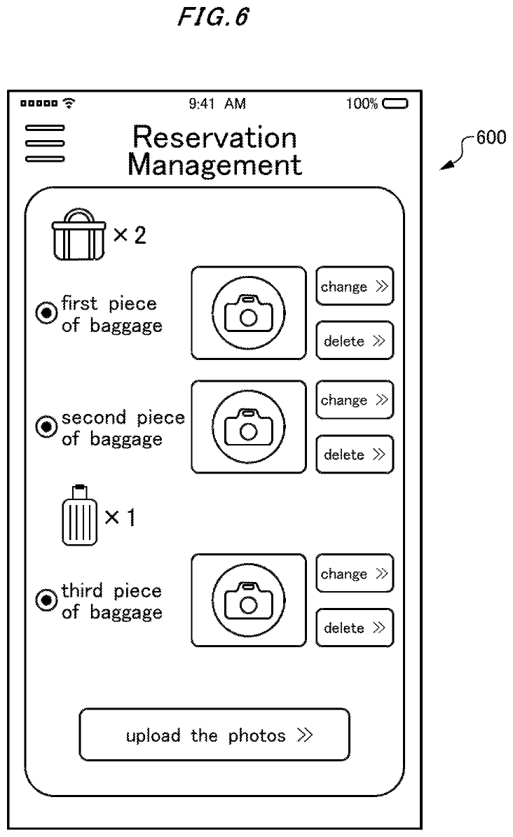

After the employee taps or clicks the check-in button 406, a photographing screen 600 as shown in FIG. 6 is displayed. Using the photographing screen 600, the employee takes a picture for each piece of baggage to be kept and send the picture to to the server 510.

When viewed from the shop device or the shop terminal 500, the device includes a display screen 501, a photographing unit 502 such as a camera for photographing a piece of baggage of a user, a communication unit 503 such as a communication interface for sending and receiving data, a processing unit 504 such as a CPU, a memory for processing data, and a storage unit 505 including a storage device or storage medium such as a hard disk, etc. for storing data. The communication unit 503 sends the photo of each of one or more pieces of baggage of a user photographed by the photographing unit 502 or a photo corresponding thereto to the server 510 or the user terminal 520. The one or more photos of one or more pieces of baggage or one or more photos corresponding thereto may be stored on the storage unit 505 of the shop terminal 500 or on a storage device or storage medium accessible from the shop terminal 500 for displaying on the display screen 501 of the shop terminal 500. The stored picture and the sent picture are not necessarily the photographed picture itself, but may be subjected to processing such as compression, modification, conversion and the like. Also, for example, photos of a plurality of pieces of baggage may be stored or sent after modification into one photo, the photos may be made into one photo per size or category.

The shop device 500 can realize each process by executing a program or an application for performing each process described in the present specification, and the program may include one or more programs, and it can be recorded on a computer readable storage medium as a non-transitory program product.

Although an example where an application is installed on the shop device 500 and each screen is displayed on the display screen 501 of the shop device 500 by the operation of the application, the web page provided by the server 510 may display on the display screen 501 of the shop device 500.

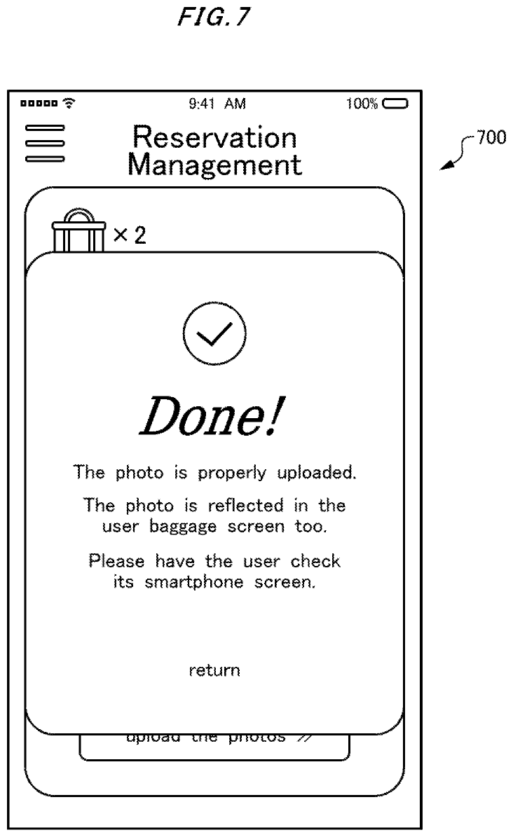

When uploaded (UL) to the server 510, the user terminal 520 also communicates with the server, and the photographed or sent photograph or the corresponding photograph can be viewed, and this serves as a certificate of receipt (See FIG. 7). There is a low possibility that the user and the shop accidentally have the same or corresponding photo, and the shop employee can correctly determine whether to return a piece of baggage, namely whether the person who came to pick up a piece of baggage is the person who deposited it by matching the photos. The photograph sent from the server 510 to the user terminal 520 is not necessarily the photograph received by the server 510, but may be one that has been subjected to processing such as compression, modification, conversion, and the like. Also, for example, a plurality of received photos may be processed into a single photo and then sent, or it may be processed into a single photo for each size or category. Instead of sending to the server 510, direct transmission to the user terminal 520 is also conceivable.

In response to the completion of the transmission, at least one of the shop device 500 and the server 510 can determine and store that the check-in is completed. In particular, the completion of the check-in may be determined in response to the completion of the transmission only. From the viewpoint of the server 510, as an example, it is possible to determine the completion of check-in in response to the completion of receipt or in response only to the completion of receipt.

The matching may be performed based on image processing on the shop terminal 500 or the server 510 in addition to being performed by an employee, so that the presentation of the matching result to the employee may be automated or the final decision or determination on whether to return based on the matching result may be automated. When automation advances, it may not always be desirable for the shop device 500 to be portable, and it may be fixed at any position of the shop and the check-in process may be started in response to a piece of baggage being placed by a user within the area in which a photograph can be taken by the photographing unit 502 or in response to an input by the user.

Although pieces of baggage are temporarily stored in the idle space of a shop, since the number of pieces of baggage kept at each shop is limited, in many cases, it is sufficient to put a name tag, a number tag, etc. as needed.

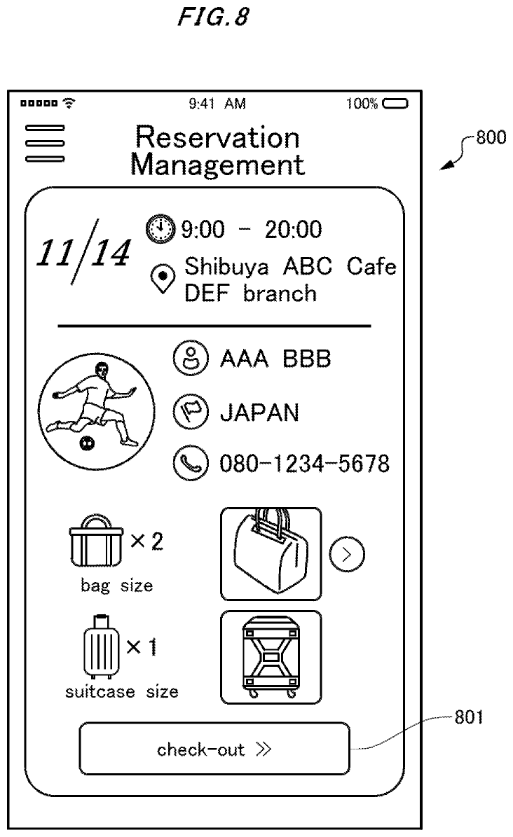

On the shop terminal, as shown in FIG. 8, the photographed image or an image associated thereto can be browsed together with other reservation information, and when a user comes to receive the luggage, it can proceed to payment by tapping or clicking the checkout button after matching of photos. If the payment information is required as the user information, the payment can be automated only by requiring the user to confirm the amount of money used at the end as needed.

The present invention which stores baggage by visual communication via photos reduces the time and load required for depositing luggage and it is especially beneficial for foreign tourists whose number is expected to grow rapidly.

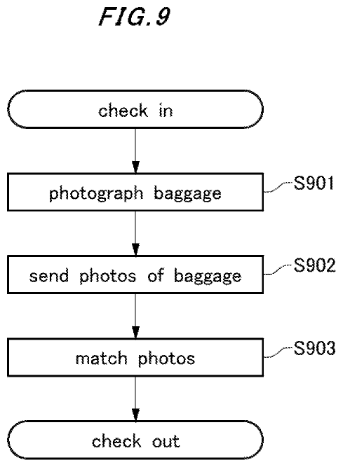

A series of processes described will look like FIG. 9 when described from the shop device point of view. For example, when check-in is started by tapping or clicking the check-in button 406 shown in FIG. 4, the shop device 500 is used to take one or more photographs of one or more pieces of baggage of the user (S901). A photo of each of the one or more pieces of baggage or a photo corresponding thereto is sent to the server 510 or the user terminal 530 (S902), and in one example, it is assumed that the check-in process is completed when the transmission is completed. When the user comes to receive one or more pieces of baggage kept, a match or verification between the photo which can be displayed on the shop device 500 and the photo displayed on the user terminal 520 is performed (S903), and if there is no problem in the matching result, for example, the checkout button 801 shown in FIG. 8 is tapped or clicked, and if necessary, the expense is paid and the checkout ends. The match can be performed for each piece of baggage captured in a photo, or the entire photo can be matched for each photo. Here, “can be displayed” means that when a match is automatically performed on the shop device 500 or the server 510, it is not always necessary to display the photograph on the shop device 500.

In case of a web application instead of an app, for example, the series of processes can be as follows: the server 510 causes reservation contents of a user to be displayed on display screen 501 of the shop device 500, receives one or more photographs of the one or more pieces of baggage of the user photographed in line with the reservation contents or one or more photographs corresponding thereto, and sends one or more photographs corresponding to the one or more pieces of baggage, wherein a match between the photos of the shop devices 500 and the user terminal 520. The server 510 comprises a communication unit such as a communication interface for sending and receiving data, a processing unit for processing data such as a processor or CPU, and a storage unit for storing data including storage device or storage medium such as a hard disk, etc. and the server 510 can be configures by executing a program for performing each process. The program may include one or more programs, and it can be stored on a computer readable medium as a non-transitory program product.

If registration of a face picture or a profile picture is essential as the user information, it can be shown simultaneously with at least part of one or a plurality of photographed images or one or a plurality of images associated thereto on the checkout screen 800. Errors when returning baggage can be suppressed only visually. The usefulness of a face picture or profile picture is similar in the check-in process.

Further, by attaching an identification symbol such as baggage number, serial number and reservation number to the photograph of a piece of baggage and giving it to the user, it becomes possible to match the symbols in addition to the photos. The identification mark may be given, for example, for each piece of baggage, for each reservation, or for each photo.

Also, as a shop, by registering so called local shops that have roots to places or regions instead of large chain stores that have stores all over the country, a new touch point between a user and a shop which is completely different from using a cold coin locker can be formed. For example, registering shops mainly from cafes, bicycle shops, kimono rental shops, temples etc. gives foreign tourists opportunities to get in touch with the uniqueness of tourist sites in particular. The reduction of the load of depositing and receiving by using the photo of one more pieces of baggage as the certificate of receipt is made possible by having the person of a shop as an intermediate. This not only shortens the time necessary to deposit in a coin locker but also generates a new touch point between persons and it have more significance than sharing idle spaces.

As a precaution, unless “only” is not described such as in the case of “only based on xx”, “only based on xx”, or “only in the case of xx”, in the present Specification, it should be noted that it is assumed that other information may also be considered.

### REFERENCE SIGNS LIST

101 map
102 shop location
103 lower area (general display area)
200 reservation screen
201 date of deposit
202 check in time
203 check out time
204 number of pieces of baggage per size
300 confirmation screen
400 check in screen
401 reserved person
402 reserved time
403 shop name
404 package number
405 profile picture
406 check in button
500 shop equipment
501 display screen
502 photographing unit
503 communication unit
504 processing unit
505 storage unit
510 server
520 user terminal
600 photography screen
700 UL complete screen
800 reservation management screen (check out screen)
801 check out button

1. A method using a shop device for keeping one or more pieces of baggage of a user at a shop, comprising steps of:
displaying reservation contents of the user to a display of the shop device,
photographing the one or more pieces of baggage of the user included in the reservation contents, and
sending a photograph of each of the one or more pieces of baggage or a photograph corresponding thereto.

2. The method according to claim 1, wherein the shop device is a portable terminal.

3. (canceled)

4. The method according to claim 1, wherein the one or more pieces of baggage include pieces of baggage respectively pertaining to different size categories.

5. The method according to claim 1, wherein the reservation contents include a face photo or a profile photo of the user.

6. The method according to claim 1, wherein the photograph of each of the one or more pieces of baggage or the photograph corresponding thereto can be displayed on the shop device.

7. The method according to claim 6, wherein at least part of the photograph of each of the one or more pieces of baggage or the photograph corresponding thereto is displayed on the shop device together with the face photo or the profile photo of the user.

8. The method according to claim 1, wherein the sending is uploading to a server which can communicate with the shop device.

9. The method according to claim 8, wherein the photograph of each of the one or more pieces of baggage or the photograph corresponding thereto uploaded to the server is displayed on a user terminal of the user.

10. The method according to claim 1, wherein the sending is sending from the shop device to the user terminal.

11. The method according to claim 10, further comprising a step of determining completion of check-in of the one or more pieces of baggage in response to completion of the sending.

12. The method according to claim 1, wherein the photograph of each of the one or more pieces of baggage or the photograph corresponding thereto includes an identification symbol.

13. The method according to claim 1, wherein whether each piece of baggage can be returned is determined based on a matching result between the photograph of each of the one or more pieces of baggage or the photograph corresponding thereto which the user displayed on a user terminal and a photograph that can be displayed on the shop device.

14. A program for having a shop device to perform a method for keeping one or more pieces of baggage of a user at a shop, the method comprising steps of:
displaying reservation contents of the user to a display of the shop device,
photographing the one or more pieces of baggage of the user in line with the reservation contents, and
sending a photograph of each of the one or more pieces of baggage or a photograph corresponding thereto.

15. (canceled)

16. A method using a shop device for keeping one or more pieces of baggage of a user at a shop, comprising steps of:
causing reservation contents of the user to be displayed on display of the shop device,
receiving one or more photographs of the one or more pieces of baggage of the user photographed in line with the reservation contents or one or more photographs corresponding thereto, and
sending the received one or more photographs or one or more photographs corresponding thereto to a user terminal of the user.

17. The method according to claim 8, further comprising a step of determining completion of check-in of the one or more pieces of baggage in response to completion of the sending.

18. The method according to claim 9, further comprising a step of determining completion of check-in of the one or more pieces of baggage in response to completion of the sending.
